(19) United States
(12) Patent Application Publication
(10) Pub. No.: US 2026/0288210 A1
(43) Pub. Date: Sep. 24, 2026

(54) FOLDABLE DEVICES WITH EXPANDING HOUSINGS

(71) Applicant: Hewlett-Packard Development Company, L.P., Spring, TX (US)

(72) Inventors: Xiang Ma, Spring, TX (US); Richard Arthur Bargerhuff, Spring, TX (US)

(73) Assignee: Hewlett-Packard Development Company, L.P., Spring, TX (US)

(21) Appl. No.: 19/085,626

(22) Filed: Mar. 20, 2025

(51) Int. Cl. G06F 1/16; G06F 3/02

(52) U.S. Cl. CPC G06F 1/1681; G06F 3/0221

(57) ABSTRACT

A foldable device may be configured to upfold and expand. The foldable device may include a first housing. The foldable device may include a first set of keys and a processing circuitry disposed within the first housing. The foldable device may include a second housing. The foldable device may include a second set of keys disposed within the second housing. The foldable device may include a hinge coupled to the first housing and the second housing. The foldable device may include a linkage coupled to the hinge, where the linkage is to expand the first housing and the second housing during a rotation of the first housing relative to the second housing via the hinge.

### BACKGROUND

The present disclosure relates to foldable electronic devices which can rotate and expand housings of the device.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are not to be considered limiting of its scope, the disclosure will be described with additional specificity and detail through use of the accompanying drawings. In the drawings, similar symbols typically identify similar components, unless context dictates otherwise.

FIG. 1A illustrates a perspective view of a foldable electronic device in a closed position.

FIG. 1B illustrates a partial perspective view of the foldable electronic device of FIG. 1A in a partially opened position.

FIG. 2A illustrates top view of the foldable electronic device of FIG. 1A in an opened position.

FIG. 2B illustrates a rear perspective view of the foldable electronic device of FIG. 2A.

FIG. 2C illustrates a side view of the foldable electronic device of FIG. 2A.

FIG. 2D a top cross-sectional schematic view of electronic components of the foldable electronic device of FIG. 2A.

FIG. 3A illustrates a perspective cross-sectional view of the foldable electronic device of FIG. 1A having a hinge with expansion linkages to open and expand the foldable electronic device.

FIGS. 3B-3D illustrate partial views of the foldable device of FIG. 3A rotating from the closed position, to a partially opened position, to the opened position.

FIG. 4 illustrates a partial cross-sectional view of a gear assembly attached to the hinge illustrated in FIG. 3A.

FIGS. 5A-5B illustrate a top view of a locking assembly for use in the foldable electronic device of FIG. 1A.

FIGS. 6A-6B illustrate another embodiment of expansion linkages to open and expand a foldable electronic device.

### DETAILED DESCRIPTION

The present disclosure generally relates to foldable electronic devices (e.g., keyboards, notebooks, laptops, smartphones, etc.) which open and close via a hinge. The hinge can be positioned between and/or connected with a first housing and a second housing of the foldable electronic device. When the device is unfolded, the first and second housings can together form an input device, such as a keyboard. The first housing can have a main printed circuit board (PCB) and thermal solutions (e.g., heat sinks, fans, cooling solutions, heat pipes, etc.). The second housing can have a battery electrically connangleected to the main PCB, such as with a cable routing through the hinge. During opening of the foldable device (e.g., by rotating the first housing relative to the second housing, or vice versa), the hinge can move a slider connected to the hinge to expand and tilt a top portion of the first and second housings. In the unfolded state, the foldable device is titled in an ergonomic position and has airflow openings which can improve the thermal performance of the foldable device. Example methods of using the foldable electronic device are also disclosed.

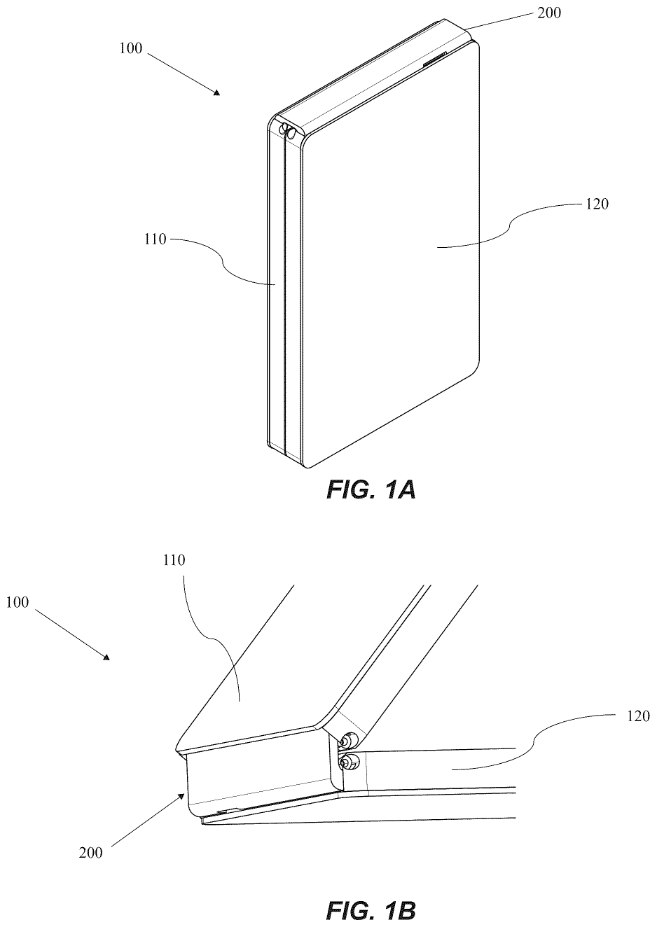

FIGS. 1A-1B illustrate an example foldable device 100 (e.g., electronic foldable device). The foldable device 100 can, for example, be a keyboard, a laptop, a smartphone, keyboard computer, or a notebook computer. With reference to FIG. 1A, the foldable device 100 is in a closed state (e.g., folded position). The foldable device 100 can have a first housing 110 (e.g., a first side of a keyboard) and a second housing 120 (e.g., a second side of a keyboard). As shown in FIG. 1B, the first housing 110 and the second housing 120 can be connected by a hinge 200 (e.g., hinge assembly, hinge mechanism). The hinge 200 can join the first housing 110 and the second housing 120 at a region adjacent to the respect ends of the first housing 110 and the second housing 120, such as at a left end of the first housing 110 and at a right end of the second housing 120.

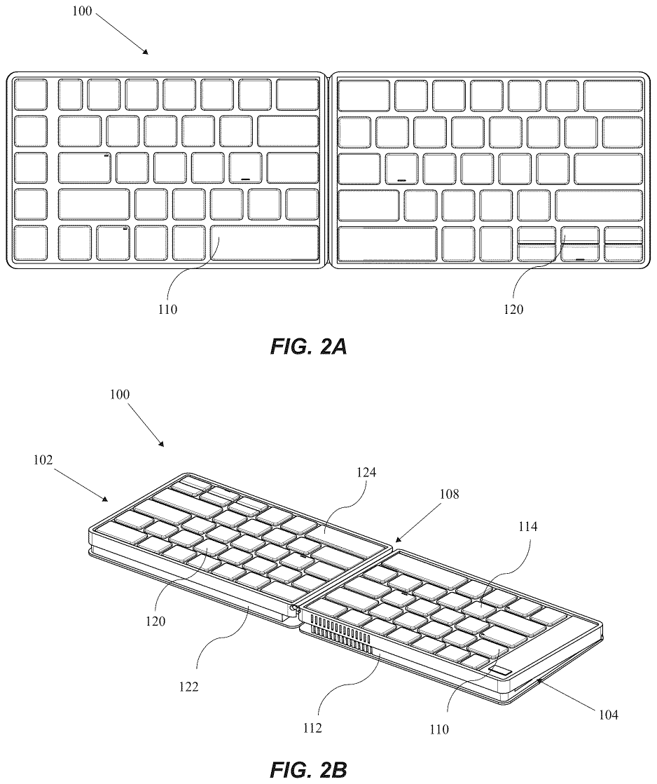

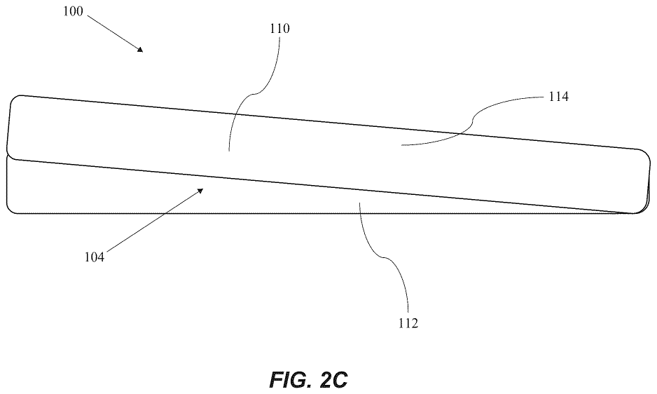

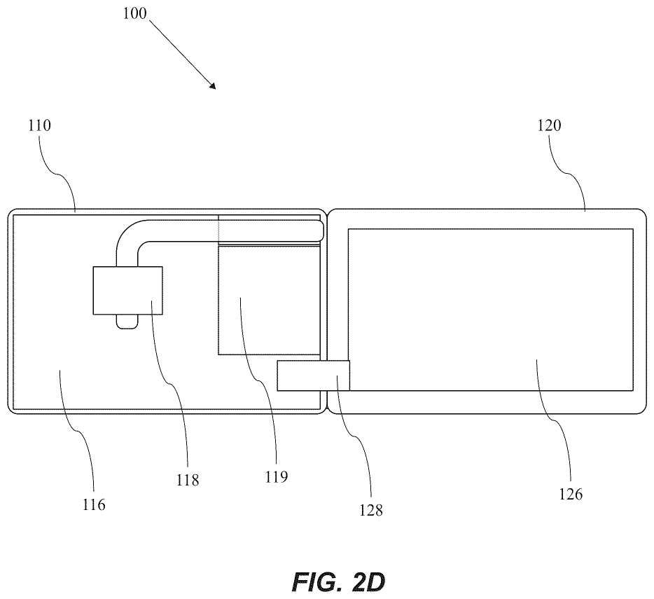

FIGS. 2A-2C illustrate the foldable device 100 in an opened (also called unfolded) position. The first housing 110 and the second housing 120 can rotate relative to each other to the open position via the hinge 200. The first housing 110 and second housing 120 can form an enclosure 102. Rotating the first housing 110 relative to the second housing 120 can enable opening of the foldable device 100 so that the top surface 114 (e.g., keyboard surface, typing surface, typing keys, display) of the first housing 110 and the top surface 124 (e.g., keyboard surface, typing surface, typing keys, display) of the second housing 120 are exposed (e.g., to form a typing surface). The first housing 110 can have a first set (e.g., plurality) of keys (e.g., typing keys) and the second housing 120 can have a second set (e.g., plurality) of keys (e.g., typing keys). The bottom surface 112 of the first housing 110 and the bottom surface 122 (e.g., base surface) of the second housing 120 can be placed on a surface (e.g., a table, desk). When unfolded, the first housing 110 and second housing 120 can be adjacent to each other at a middle region 108. At the middle region 108 there can be little to no gap or space (e.g., approximately 0.1 mm space) between the first housing 110 and the second housing 120, Having essentially zero gap at the middle region 108 can create a more ergonomic experience (e.g., ergonomic typing surface) when using the foldable device 100.

The foldable device 100 can be tilted when in the open state position. The top surface 114 can be tilted relative to the bottom surface 112 (the top surface 124 can also be tilted relative the bottom surface 122). A side region 104 (as shown in FIGS. 2B and 2C) of the foldable device 100 (e.g., the side region 104 positioned along first housing 110 or second housing 120) can extend along a non-zero angle (e.g., about 5 degrees) relative to bottom surface 112 and/or bottom surface 122. In certain implementations, the tilt angle (the angle between the top and bottom surfaces 112, 114) is at least about 3° and/or less than or equal to about 7°. In some variants, the tilt angle is at least approximately: 2°, 4°, 6°, 8°, 10°, or otherwise. The foldable device 100 can be expanded in the open state relative to a closed state (see FIG. 1A). The top surfaces 114, 124 can expand approximately 5 mm to 6 mm relative to the bottom surfaces 112, 122. In various embodiments, the first and second housings 110, 120 each include a pivot. As discussed in more detail below, during unfolding of the device 100, the first and second housings 110, 120 expand, which can result in the top surfaces 114, 124 being tilted. For example, the top surfaces 114, 124 can rotate about the pivot such that a rear of the first and second housings 110, 120 is at a higher elevation (e.g., raises) than the front of the first and second housings 110, 120, as shown in FIG. 2B. In certain implementations, the first and second housings 110, 120 each have an upper housing portion (e.g., D cover) and a lower housing portion (e.g., D cover). The upper and lower housing portions can be connected with the pivot. The upper and lower housing portions can be configured to move relative to each other, such as by a rear of the upper housing portion pivoting relative to a rear of the lower housing portion.

FIG. 2D schematically illustrates certain internal components of the foldable device 100. The internal components can be within the enclosure 102 (e.g., within the first housing 110 and second housing 120). The first housing 110 can include a main printed circuit board (PCB) 116, a central processing unit (CPU) 118, and a fan 119. The second housing 120 can include a battery 126. The PCB 116 can be connected (e.g., electrically coupled) to the battery 126, such as via a flexible printed circuit (FPC) 128. The FPC 128 can be routed through the hinge 200. The battery 126 can power the PCB 116.

When the foldable device 100 is in the open state the foldable electronic device 100 can be operational (e.g., the keyboard can be used for typing). In the open state, the foldable device 100 can expand (e.g., the top surfaces 114, 124 can expand relative to the bottom surfaces 112, 122). The battery 126 can provide power to the PCB 116 so that the device is operational. When operational, the foldable device 100 may generate heat due to the battery 126 and the other electronic components (e.g., PCB 116, CPU 118, FPC 128). Expanding the enclosure 102 can provide more space within the enclosure 102 to allow heat to dissipate (e.g., due to improved airflow, enhance heat transfer). Expanding the enclosure 102 can position in the top surfaces 114, 124 further away from heat sources (e.g., the electronic components including the PCB 116, CPU 118, battery 126) on the bottom surfaces 112, 122, which can inhibit heat transfer to the top surfaces 114, 124 and/or can allow the foldable device 100 to be cooler to the touch of a user (e.g., a cool typing surface). Expanding the enclosure 102 can position the top surfaces 114, 124 closer to a user which can be more ergonomic.

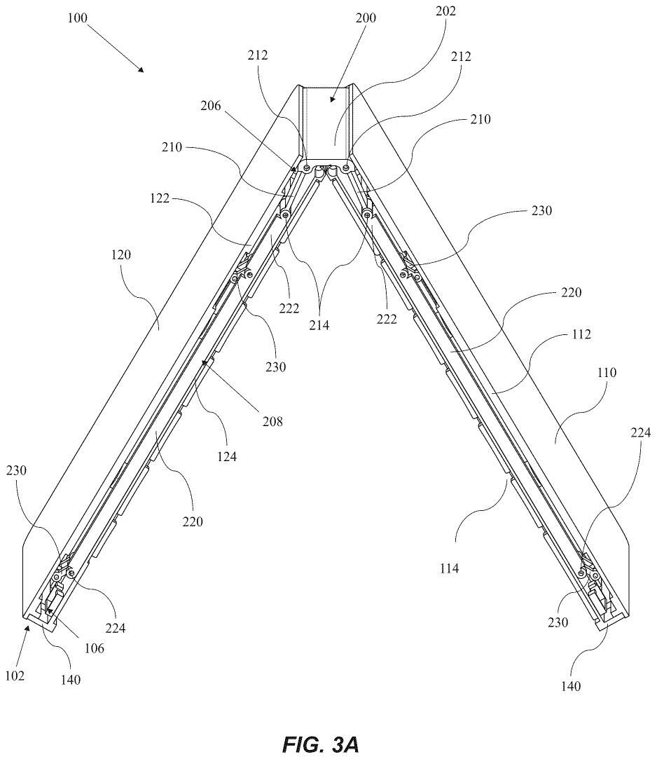

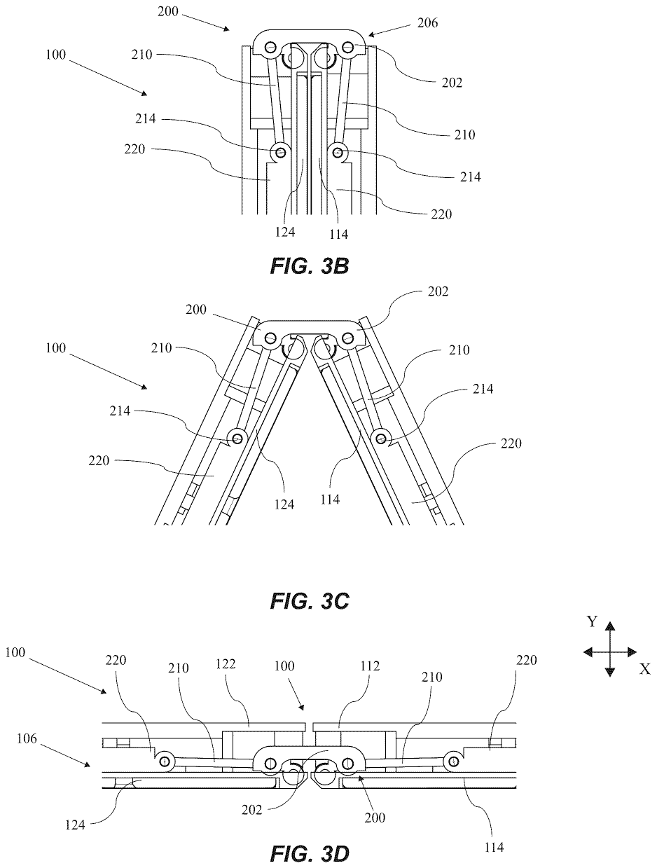

FIG. 3A illustrates a cross-sectional view of the foldable device 100 and the hinge 200 in a partially opened (e.g., partially unfolded) position. The hinge 200 can have a connector 202. The connector 202 can be positioned partially within and/or adjacent to the first housing 110 and the second housing 120. As illustrated, the connector 202 can cover and/or obscure an open region 206 between the first and second housings 110, 120 and/or can inhibit or prevent the creation of a pinch-point between the first and second housings 110, 120.

The hinge 200 can include an expansion linkage 208 (e.g., a set of expansion linkages). The expansion linkage 208 can include a first lever 210, a link 220, and/or a second lever 230. The link 220 can be a slider. The first lever 210 can be connected to the connector 202 at a first end 212. The second end 214 of the first lever 210 can be connected to the link 220. The second end 214 of the first lever 210 can couple to a first coupling region 222 of the link 220. The link 220 can extend through the enclosure 102 (e.g., an opening 106 formed between the top surfaces 114, 124, and bottom surfaces 112, 122) and/or towards terminal ends 140 of the enclosure 102. The slider can extend along the enclosure 102 towards a second end region 224. The second lever 230 can be connected to the link 220. The second lever 230 can be multiple second levers 230 (e.g., two, three, four) coupled to and positioned along the length of the link 220. For example, a second lever 230 can be positioned near or adjacent to the first coupling region 222 of the link 220. The second lever 230 can be positioned near or adjacent to the second end region 224 of the link 220. The second lever 230 can extend from the link 220 to a surface of the foldable device 100 (e.g., to the bottom surfaces 112, 122 of the first housing 110 and second housing 120). As shown, in several implementations, the expansion linkage 208 is located on a rear of the device 100, such as on a rear of the first and second housings 110, 120.

As the foldable device 100 rotates to an open position (e.g., the first housing 110 rotates relative to the second housing 120) the connector 202 can move the first lever 210 away from the hinge 200 and move (e.g., translate) the link 220 along the enclosure (e.g., along the first housing 110 and second housing 120 away from the hinge 200). As the foldable device 100 rotates to the open position, the link 220 can actuate (e.g., rotate) the second lever 230 such that the second lever 230 expands and tilts the top surfaces 114, 124 relative to the bottom surfaces 112, 122. For example, the rear of the top surfaces 114, 124 can expand outwardly and/or upwardly relative to the bottom surfaces.

FIGS. 3B-3D illustrate partial views of the foldable device 100 near the hinge 200 as the foldable device 100 rotates from the closed position (e.g., folded position) to the open position (e.g., unfolded position). FIG. 3B shows the foldable device 100 in the folded position (e.g., completely folded position). The top surfaces 114, 124 can face each other (e.g., extend along the same parallel axis and/or be positioned adjacent or in abutment with each other) in the folded position. The connector 202 is positioned adjacent to openings (e.g., the open region 206) of the first housing 110 and the second housing 120. The connector 202 can be exposed to a user (e.g., a user can visibly see the connector 202) and/or can be on an exterior of the device when in the folded position. The first lever 210 is coupled to (e.g., attached, affixed, etc.) the link 220 at the second end 214. In some implementations, the first lever 210 is completely positioned in and/or does not extend out of the first housing 110 and/or second housing 120. As illustrated in FIG. 3B, in certain implementations, in the closed position, the connector 202 can form a lateral end of device 100, protrude laterally outward from the bottom surfaces 112, 122, extend in a generally perpendicular direction to the top surfaces 114, 124 and/or the bottom surfaces 112, 122, and/or substantially or completely span a gap (e.g., open region 206) between the bottom surfaces 112, 122.

FIG. 3C shows the foldable device 100 in a partially opened position (e.g., the first housing 110 is rotated further away from the second housing 120). As the foldable device 100 begins to unfold from the position in FIG. 3B (e.g., the first housing 110 rotates relative to the second housing 120), the connector 202 begins to move (e.g., translate) the first lever 210 along and within the first housing 110 and second housing 120. As the first lever 210 moves along and within the first housing 110 and second housing 120, the first lever 210 moves the link 220 along the first housing 110 and second housing 120. The link 220 can slidably engage (e.g., be positioned against) an inner wall of the first housing 110 and second housing 120. The link 220 can slide along an inner wall adjacent to the top surfaces 114, 124. In certain implementations, as the link 220 slides along the first housing 110 and/or second housing 120, the link 220 actuates the second lever 230 to expand the first housing 110 and second housing 120 to increase the size of the opening 106 (e.g., form a space) and tilt the top surfaces 114, 124 relative to the bottom surfaces 112, 122. As illustrated in FIG. 3C, in certain implementations, in the partially opened position, the connector 202 can substantially or completely span a gap between the top surface 114 and bottom surface 112 and/or the top surface 124 and bottom surface 122, and/or can be visible by a user. As further illustrated, the connector 202 can have rounded ends. The rounded ends can be to engage with (e.g., slide along) inner sides of the bottom surfaces 112, 122.

FIG. 3D shows the foldable device 100 in the opened position (e.g., a fully open position such that the top surface 114 of the first housing 110 is generally parallel to the top surface 124 of the second housing 120). Compared to the position in FIG. 3C, the connector 202 has moved the first lever 210 further into the first housing 110 and second housing 120. As the first lever 210 moves the first lever 210 further into the first housing 110 and second housing 120, the first lever 210 moves (e.g., translates) the link 220 further along the inner wall of the top surfaces 114, 124. In some implementations, as the link 220 move along the inner wall of the top surfaces 114, 124, the link 220 actuates the second lever 230. Such actuation of the lever 230 can increase the opening 106 (e.g., form or increase the size of a space) within the first housing 110 and second housing 120 (e.g., the enclosure 102) and/or tilt the top surfaces 114, 124 relative to the bottom surfaces 112, 122. In several variants, as the link 220 slides along the inner wall of the top surfaces 114, 124, the enclosure 102 can expand and tilt (e.g., the top surfaces 114, 124 are angled relative to the bottom surfaces 112, 122) simultaneously. The top surfaces 114, 124 can tilt about 5 degrees relative to the bottom surfaces 112, 122. The top surfaces 114, 124, the enclosure 102 can expand at least about 5 mm and/or less than or equal to about 6 mm relative to the bottom surfaces 112, 122. In certain implementations, the rear of the top surfaces 114, 124 are configured to expand, relative to the rear of the bottom surfaces 112, 122, at least about: 2 mm, 3 mm, 4 mm, 5 mm, 6 mm, 7 mm, 8 mm, or more. The link 220 can slide approximately at least about 5 mm and/or less than or equal to about 6 mm within the first housing 110 and second housing 120. As illustrated in FIG. 3D, in certain implementations, in the opened position, the connector 202 can be positioned inside the foldable device 100, vertically between the top surfaces 114, 124 and bottom surfaces 112, 122, and/or generally or completely hidden from a user's view.

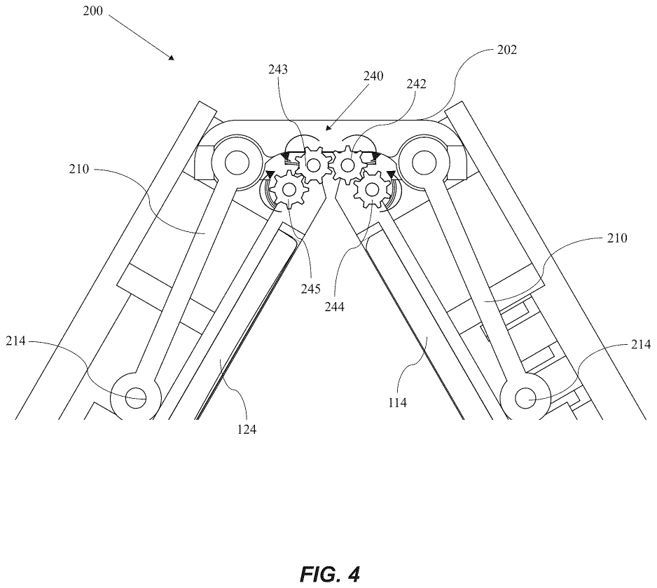

Certain implementations have a transmission assembly to control rotation of the housings 110, 120 and/or to transmit torque to elements of the hinge 200. For example, as shown in FIG. 4, the hinge 200 can include a gear assembly 240. The gear assembly 240 can be positioned along the connector 202. The gear assembly 240 can include a plurality of gears, such as a first gear 242, a second gear 243, a third gear 244, and a fourth gear 245. The gear assembly 240 can synchronize rotation of the first housing 110 relative to the second housing 120 (e.g., the first housing 110 does not freely rotate relative to the second housing 120, the first housing 110 rotates with the second housing 120 from the open to closed position and vice versa). The first gear 242 can be coupled to the second gear 243. As the first gear 242 rotates in a first direction (e.g., due to the first housing 110 rotating to open the foldable device 100), the second gear 243 rotates in an opposite direction. The first gear 242 can rotate at approximately the same speed as the second gear 243. The first gear 242 can be approximately the same size as the second gear 243. The first gear 242 can be coupled to the third gear 244. As the first gear 242 rotates in the first direction (e.g., as the foldable device 100 rotates open), the third gear 244 rotates in an opposite direction. The first gear 242 can rotate at approximately the same speed as the third gear 244. The first gear 242 may rotate at a different (e.g., faster) rate (e.g., rotational speed) than the third gear 244. The third gear 244 may be a different size (e.g., larger than) the first gear 242. The second gear 243 can be coupled to the fourth gear 245. As the second gear 243 rotates in a second direction, the fourth gear 245 can rotate in an opposite direction. The second gear 243 can rotate at approximately the same speed as the fourth gear 245. The second gear 243 can rotate at a different rate (e.g., faster) than the fourth gear 245. The fourth gear 245 can be a different size (e.g., larger) than the second gear 243.

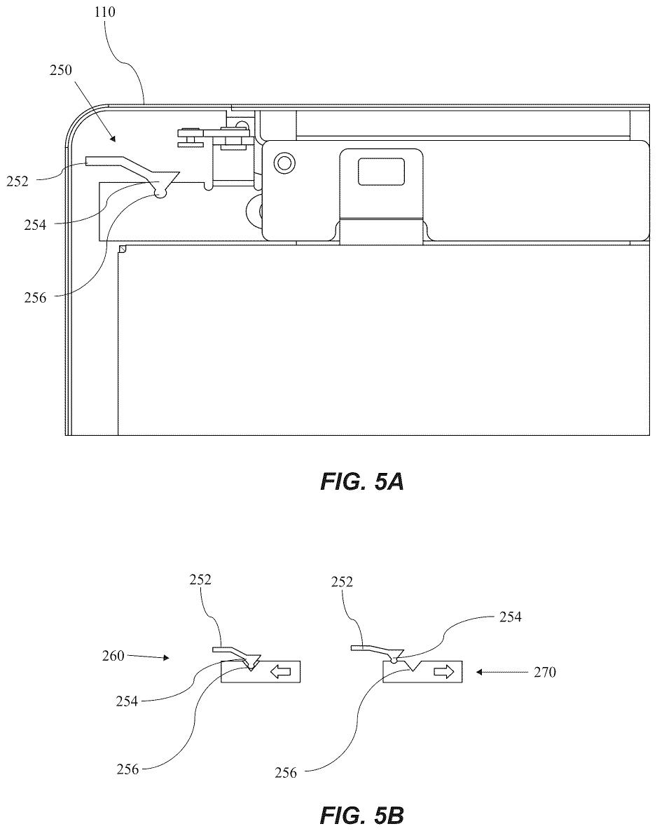

Some implementations are configured to selectively secure and/or maintain the device 100 in the closed and/or opened position. For example, as shown in FIGS. 5A and 5B, the device 100 can include a locking (e.g., securing) assembly 250. The locking assembly 250 can be positioned within the first housing 110 and/or the second housing 120. In some variants, the locking assembly 250 comprises a detent (e.g., ball detent), latch, clasp, or otherwise.

In certain implementations, the locking assembly 250 can include a body 252, a head 254, and a notch 256. The locking assembly 250 can be in locked state 260. The body 252 can be actuated (e.g., by a spring or external force) and move the head 254 within the notch 256. The locking assembly 250 can be in an unlocked state 270. The body 252 is not actuated (e.g., by a spring or external force) and the head 254 is away from (e.g., not engaging) the notch 256.

In some variants, when the foldable device 100 is in the opened state (e.g., the enclosure 102 is expanded and tilted), the locking assembly 250 can be in the locked state 260. To close the foldable device 100 (e.g., by rotating the first housing 110 relative to the second housing 120) a force can be exerted on the body 252 to move the head 254 out of and away from the notch 256. In some variants, when the foldable device 100 is in the closed state, the locking assembly 250 can be in the locked state 260. To open the foldable device 100 a force can be exerted on the body 252 to move the head 254 out of and away from the notch 256.

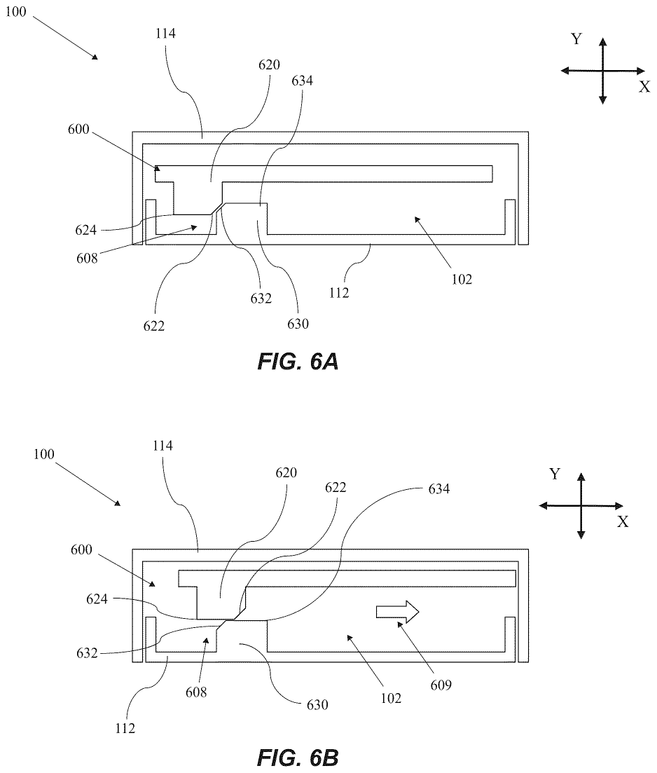

FIGS. 6A-6B illustrate another embodiment of the foldable device 100 having a hinge region or hinge 600 as the foldable device 100 rotates from the closed position (e.g., folded position as shown in FIG. 6A) to the open position (e.g., unfolded position as shown in FIG. 6B). A cam linkage 608 (e.g., a set of cam expansion linkages) can be coupled to the hinge 600. The cam linkage 608 can include a cam and a follower, such as a slider 620 and a rib 630. As the foldable device 100 rotates from the closed position to the open position, the cam linkage 608 can open the device. For example, the slider 620 can abut against and move the rib 630 to expand the enclosure 102 and tilt the top surface 114 relative to the bottom surface 112. Although not shown, the slider 620 can abut against and move the rib 630 to tilt the top surface 114 relative to the bottom surface 112. In several embodiments, the slider 620 and rib 630 move in different directions, such as in generally perpendicular directions and/or laterally outward versus vertically outward. For example, the slider 620 can move in a positive X-direction or in an expansion direction 609 in order to expand the enclosure 102. When the foldable device 100 is in the fully open position, the rib 630 can support (e.g., provide a physical interference with) the slider 620 in the expanded state (e.g., the cam linkages 608 supports the enclosure 102 in the expanded state). For example, a top of the rib 630 can rest on a bottom of the slider 620. During folding of the foldable device 100, the slider 620 can retract (e.g., slide away from the rib 630), thereby removing the interference with the rib 630. This can enable the enclosure 102 to retract in size.

The slider 620 can have a first cam surface 622 and a bottom cam surface 624. The rib 630 can have a second cam surface 632 and a top cam surface 634. The rib 630 can extend from an inner wall of the bottom surface 112. The first cam surface 622 of the slider 620 can slide along the second cam surface 632 of the rib 630 as the first housing 110 rotates relative to the second housing 120 from a closed position to the open position. As the foldable device 100 rotates to the fully opened position, the first cam surface 622 can rest on the second cam surface 632 to support (e.g., lock) the foldable device 100. As the first cam surface 622 slides along the second cam surface 632, the enclosure 102 can expand and the top surface 114 can tilt relative to the bottom surface 112. As the first cam surface 622 slides along the second cam surface 632 to open the foldable device 100, the slider 620 drives the rib 630 down (e.g., along the negative Y-axis). The first cam surface 622 can be adjacent to the top cam surface 634. In the fully open position, the bottom cam surface 624 can rest on and be in contact with the top cam surface 634. The bottom cam surface 624 of the slider 620 can rest on the top cam surface 634 of the rib 630 to support the expanded enclosure 102 and to maintain a tilt (e.g., angle) between the top surface 114 and the bottom surface 112. When in the closed (e.g., folded) position, the first cam surface 622 is not in contact with and/or is spaced away from the second cam surface 632.

While the above detailed description has shown, described, and pointed out certain novel features of the present disclosure as applied to various examples, it will be understood that various omissions, substitutions, and changes in the form and details of the device or process illustrated may be made by those skilled in the art without departing from the spirit of the present disclosure. For example, although certain examples are described above with keys and circuitry in one housing (e.g., the first housing) and different keys, circuity, and power systems (e.g., a battery) in another housing (e.g., the second housing), certain variants can swap the locations of the keys, circuitry, and power systems. As will be recognized, the present disclosure may be embodied within a form that does not provide all of the features and benefits set forth herein, as some features may be used or practiced separately from others. All changes which come within the meaning and range of equivalency of the claims are to be embraced within their scope.

The term “comprising” as used herein is synonymous with “including,” “containing,” or “characterized by,” and is inclusive or open-ended and does not exclude additional, unrecited elements or method steps. With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

Unless otherwise explicitly stated, articles such as “a” or “an” should generally be interpreted to include one or more described items. Accordingly, phrases such as “a device to” are intended to include one or more recited devices. Such one or more recited devices can also be collectively configured to carry out the stated recitations. For example, “a device to carry out recitations A, B and C” can include a first device to carry out recitation A working in conjunction with a second device to carry out recitations B and C.

All numbers expressing quantities, dimensions, and so forth used in the specification and claims are to be understood as being modified in all instances by the term “about.” Accordingly, unless indicated to the contrary, the numerical parameters set forth in the specification are approximations that may vary depending upon the desired properties sought to be obtained by examples of the present disclosure. At the very least, and not as an attempt to limit the application of the doctrine of equivalents to the scope of the claims, each numerical parameter should be construed in light of the number of significant digits and ordinary rounding approaches. For example, terms such as about, approximately, substantially, and the like may represent a percentage relative deviation, in various examples, of ±1%, ±5%, ±10%, or ±20%. The term “generally” as used herein represents a value, amount, or characteristic that predominantly includes or tends toward a particular value, amount, or characteristic. As an example, in certain embodiments, as the context may permit, the term “generally parallel” can refer to something that departs from exactly parallel by less than or equal to 20 degrees and the term “generally perpendicular” can refer to something that departs from exactly perpendicular by less than or equal to 20 degrees.

The illustrative examples described in the detailed description, drawings, and claims are not meant to be limiting. Other examples may be utilized, and other changes may be made, without departing from the spirit or scope of the subject matter presented here. The drawings are drawn to scale, but such scale should not be interpreted as limiting and some features may be enlarged or reduced for purposes or presentation. The drawings may omit some features for the sake of clarity. The relative dimensions and proportions as shown are not intended to limit the present disclosure. It will be readily understood that the aspects of the present disclosure, as generally described herein, and illustrated in the figures, can be arranged, substituted, combined, and designed in a wide variety of different configurations, all of which are explicitly contemplated and make part of the present disclosure.

The above description discloses several devices and associated methods of the present disclosure. The present disclosure is susceptible to modifications in the devices and methods, as well as alterations in the fabrication methods and equipment. Such modifications will become apparent to those skilled in the art from a consideration of this disclosure. Consequently, it is not intended that the present disclosure be limited to the specific examples disclosed herein, but that it covers all modifications and alternatives coming within the true scope and spirit of the present disclosure.

What is claimed is:

1. A foldable device comprising:
a first housing, the first housing comprising a first set of keys and a processing circuitry;
a second housing, the second housing comprising a second set of keys and a battery;
a hinge coupled to the first housing and the second housing; and
a set of expansion linkages coupled to the hinge;
wherein the set of expansion linkages is to expand the first housing and the second housing during a rotation of the first housing relative to the second housing via the hinge.

2. The foldable device of claim 1, wherein the set of expansion linkages comprises:
a first lever having a first end and a second end, the first end affixed to the hinge;
a slider coupled to the second end of the first lever, the slider extending through the first housing and the second housing; and
a second lever coupled to the slider, the first housing, and the second housing.

3. The foldable device of claim 2, wherein, during the rotation of the first housing, the slider is to translate in a direction away from the hinge.

4. The foldable device of claim 2, wherein, during the rotation of the first housing, the second lever is to rotate to expand and tilt a top surface of the first housing and the second housing relative to a bottom surface of the first housing and the second housing.

5. The foldable device of claim 1, further comprising a flexible printed circuit routed through the hinge, wherein the flexible printed circuit is to connect the first set of keys to the second set of keys.

6. The foldable device of claim 1, further comprising a lock to secure the first housing relative to the second housing in an open state.

7. The foldable device of claim 1, further comprising a set of gears coupled to the hinge.

8. The foldable device of claim 7, wherein the set of gears is to synchronize the rotation of the first housing relative to the second housing.

9. The foldable device of claim 1, further comprising a heat transfer device, wherein expanding the first housing and the second housing is to enhance heat transfer from the heat transfer device.

10. A foldable device comprising:
an enclosure having a first housing and a second housing, the first housing comprising a printed circuit board, the first housing and the second housing coupled to each other via a hinge, the hinge to rotate the first housing relative to the second housing; and
a set of expansion linkages coupled to the hinge;
wherein, during rotation of the first housing to an open position:
the set of expansion linkages is to expand the enclosure to raise a rear of the first housing and the second housing, relative to a front of the first housing and the second housing, and to simultaneously tilt a surface of the enclosure.

11. The foldable device of claim 10, wherein the set of expansion linkages comprises:
a first lever having a first end and a second end, the first end affixed to the hinge;
a slider coupled to the second end of the first lever, the slider extending through the first housing and the second housing; and
a second lever coupled to the slider, the first housing, and the second housing.

12. The foldable device of claim 11, wherein, during the rotation of the first housing to the open position, the slider is to translate in a direction away from the hinge.

13. The foldable device of claim 11, wherein, during the rotation of the first housing, the second lever is to rotate to expand and tilt a top surface of the first housing and the second housing relative to a bottom surface of the first housing and the second housing.

14. The foldable device of claim 10, further comprising a flexible printed circuit routed through the hinge.

15. The foldable device of claim 10, further comprising a lock to secure the first housing and the second housing in an expanded state.

16. A foldable device comprising:
an enclosure having a first housing and a second housing, the first housing comprising a printed circuit board;
a hinge coupled to the first housing and the second housing, the hinge to enable the first housing to rotate relative to the second housing from a closed position to an opened position; and
a cam linkage coupled to the hinge;
wherein, during at least some of a rotation of the first housing from the closed position to the opened position, the cam linkage is to expand the enclosure and to tilt a top surface of the enclosure relative to a bottom surface of the enclosure; and
wherein, when the first housing is in the opened position, the cam linkage is to support the enclosure in an expanded state.

17. The foldable device of claim 16, wherein the cam linkage comprises:
a slider having a first cam surface; and
a rib having a second cam surface.

18. The foldable device of claim 17, wherein, during rotation of the first housing to the opened position, the first cam surface is to contact and to slide relative to the second cam surface to expand the first housing and the second housing.

19. The foldable device of claim 17, wherein, when the first housing is closed relative to the second housing, the first cam surface is spaced away from the second cam surface.

20. The foldable device of claim 16, wherein the first housing and the second housing rotate synchronously.
